(19) United States
(12) Patent Application Publication
(10) Pub. No.: US 2022/0072723 A1
(43) Pub. Date: Mar. 10, 2022

(54) FADE COMB FOR AN ELECTRIC HAIR TRIMMER

(71) Applicant: Spectrum Brands, Inc., Middleton, WI (US)

(72) Inventors: David Yet Toy, Middleton, WI (US); Thomas Manders Franklin, Middleton, WI (US); Michael John deGrood, Madison, WI (US)

(21) Appl. No.: 17/016,089

(22) Filed: Sep. 9, 2020

(51) Int. Cl. B26B 19/38; B26B 19/20

(52) U.S. Cl. CPC B26B 19/3813; B26B 19/20

(57) ABSTRACT

A comb for an electric trimmer includes a first outer tooth, a second outer tooth, and intermediate teeth positioned between the first outer tooth and the second outer tooth. Each of the teeth includes a skin-contacting edge and a slot defined between an overhang region and a base region located on the blade-facing side. Each intermediate tooth defines a tooth height representing the shortest distance between a base region and an outer-most point on the skin-contacting edge of each of the intermediate teeth. A first tooth height is defined by a first intermediate tooth and a second tooth height is defined by a second intermediate tooth. The first tooth height is greater than the second tooth height. The ratio between the first tooth height and the second tooth height is about 1:70 to about 3:16.

### BACKGROUND

The present invention relates generally to attachments for grooming appliances and, more particularly, to comb attachments for electric hair trimmers.

Conventional electric hair trimmers include a blade assembly for cutting human or animal hair. The electric hair trimmers may include removable comb attachments that allow the user to cut the hair to different lengths. Typically, to switch cut lengths the user of the electric hair trimmer must remove a comb attachment from the blade assembly and replace it with a different comb attachment or adjust a setting of the comb attachment.

When cutting hair, the user of the electric hair trimmer may change the cut length, e.g. by changing comb attachments, so that hair is cut to different lengths in different areas. In one conventional haircutting technique, known as “fading” or “a fade cut,” the user cuts a person's hair to varying lengths along the sides and the back of the head. For example, a 3 mm comb attachment or setting may be used to cut hair in an area above the neck for a specified distance to create a 3 mm trim zone, and a 6 mm comb attachment or setting may be used to cut the hair in an area above the 3 mm trim zone, creating a 6 mm trim zone.

Accordingly, fading allows the user of the electric hair trimmer to create a transitioned appearance between the neck, which typically has shorter hair, and the top of the head, which typically has longer hair. However, the hair at the transition between each zone can appear uneven when the hair is faded using discrete settings (e.g. a 3 mm comb and a separate 6 mm comb). Additionally, a user would have to change the cut length between each trim zone by switching between multiple comb attachments or switching between multiple settings on the same attachment.

Thus, there is a need for a comb attachment or a set of comb attachments for an electric hair trimmer that that facilitates a smooth, even transition between the shorter and longer hair lengths when fading.

### BRIEF DESCRIPTION

In one embodiment, a comb for an electric trimmer is provided. The comb has a skin-facing side including a skin-facing surface and a blade-facing side including a planar blade-abutting surface. The comb also includes teeth that project from the skin-facing surface and the planar blade-abutting surface. The teeth include a first outer tooth, a second outer tooth, and intermediate teeth. The intermediate teeth are spaced apart from each other and positioned between the first outer tooth and the second outer tooth. The intermediate teeth include a first intermediate tooth and a second intermediate tooth. Each of the teeth comprises a proximal end adjacent the skin-facing surface, a distal end, a skin-contacting edge between the proximal end and the distal end, an overhang region, a base region located on the blade-facing side, and a slot formed between the overhang region and the base region. The slot configured to receive at least one blade of a blade assembly. Each intermediate tooth defines a tooth height. The tooth height for each of the intermediate teeth represents the shortest distance between the base region and an outer-most point on the skin-contacting edge of each of the intermediate teeth. A first tooth height defined by the first intermediate tooth is greater than a second tooth height defined by the second intermediate tooth. The first ratio between the first tooth height and the second tooth height is about 1:70 to about 3:16.

In another embodiment, a comb for an electric trimmer is provided. The comb has a back, a front, a first side edge extending from the back to the front, and a second side edge extending from the back to the front and opposite the first side edge. At least one of the back and the front includes a blade engagement section for removeably coupling the comb to the blade assembly. The comb also includes teeth extending to the front. Each of the teeth has a tip. The teeth include a first outer tooth located at or adjacent the first side edge, a second outer tooth located at or adjacent the second side edge, and intermediate teeth spaced apart from each other and positioned between the first outer tooth and the second outer tooth. The intermediate teeth include a first intermediate tooth and a second intermediate tooth. Each intermediate tooth defines a tooth height. A first tooth height defined by the first intermediate tooth is greater than a second tooth height defined by the second intermediate tooth. A first ratio between the first tooth height and the second tooth height is about 1:70 to about 3:16.

In another embodiment, a comb for an electric trimmer is provided. The comb has a back, a front, a first side edge extending from the back to the front, and a second side edge extending from the back to the front and opposite the first side edge. At least one of the back and the front includes a blade engagement section for removeably coupling the comb to the blade assembly. The comb also includes teeth extending to the front. Each of the teeth has a tip. The teeth include a first outer tooth located at or adjacent the first side edge, a second outer tooth located at or adjacent the second side edge, and intermediate teeth spaced apart from each other and positioned between the first outer tooth and the second outer tooth. The intermediate teeth include a first intermediate tooth directly adjacent the first outer tooth, a second intermediate tooth directly adjacent the second outer tooth, and a pair of adjacent intermediate teeth. A first distance is defined between the first outer tooth and the first intermediate tooth. A second distance is defined between the second outer tooth and the second intermediate tooth. An intermediate tooth distance is defined between the pair of adjacent intermediate teeth. Both the first distance and the second distance are greater than the intermediate tooth distance.

### DRAWINGS

FIG. 1 is a top view of an electric hair trimmer having a blade assembly, one suitable embodiment of a fade comb of the present disclosure being attached to the blade assembly of the trimmer;

FIG. 2 is an enlarged side view of a portion of the trimmer having the fade comb attached to the blade assembly of the trimmer;

FIG. 3 is a bottom view of the trimmer of FIG. 1 illustrating the fade comb attached to the blade assembly of the trimmer;

FIG. 4 is a schematic view of the trimmer of FIG. 1 illustrating operation of the trimmer to cut hair with the fade comb removed from the blade assembly;

FIG. 5A is a top view of a first fade comb of a pair of fade combs for use with the trimmer of FIG. 1 for cutting hair at a first length along a first side of a person's head;

FIG. 5B is a top view of a second fade comb of the pair of fade combs for use with the trimmer of FIG. 1 for cutting hair at the first length along a second side of a person's head;

FIG. 6 is an enlarged view of a portion of the first fade comb indicated by an area 600 in FIG. 5A, the first fade comb including a plurality of teeth, each tooth of the plurality of teeth having a different length relative to the other teeth;

FIG. 7 is a bottom view of the first fade comb of FIG. 5A illustrating a back blade engagement section and a front blade engagement section;

FIG. 8 is a perspective view of the first fade comb of FIG. 5A illustrating the blade-facing side;

FIG. 9 is a cross-sectional view of the first fade comb of FIG. 5A taken along line 9-9 in FIG. 7;

FIG. 10 is a cross-sectional view of the first fade comb of FIG. 5A taken along line 10-10 in FIG. 7;

FIG. 11 is a top view of the electric hair trimmer of FIG. 1 and the first fade comb of FIG. 5B illustrating the first fade comb passing along a person's skin;

FIG. 12 is a schematic view of a row of trimmed hair taken along line 12-12 in FIG. 11, and illustrating a fade cut, the hair is faded from a first height to a second height; and

FIG. 13 is a flow diagram of a method of cutting a fade cut in a person's hair.

Corresponding reference characters indicate corresponding parts throughout the several views of the drawings.

We have invented a new design for a fade comb for an electric hair trimmer.

FIG. 14 is a first perspective view of a FIRST COMB showing our new design.

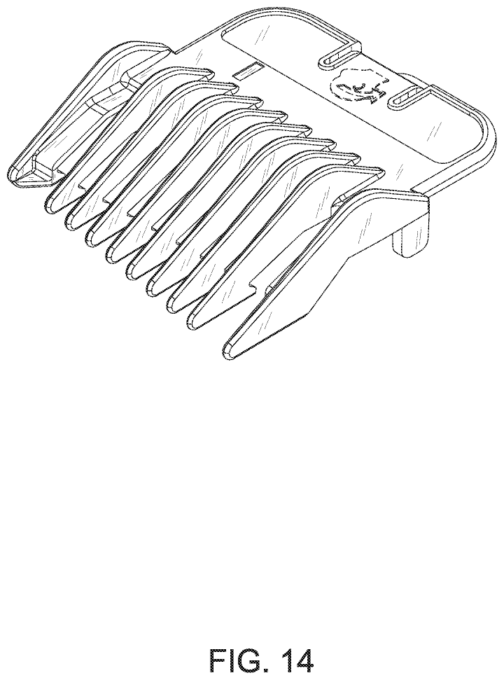

FIG. 15 is a second perspective view thereof.

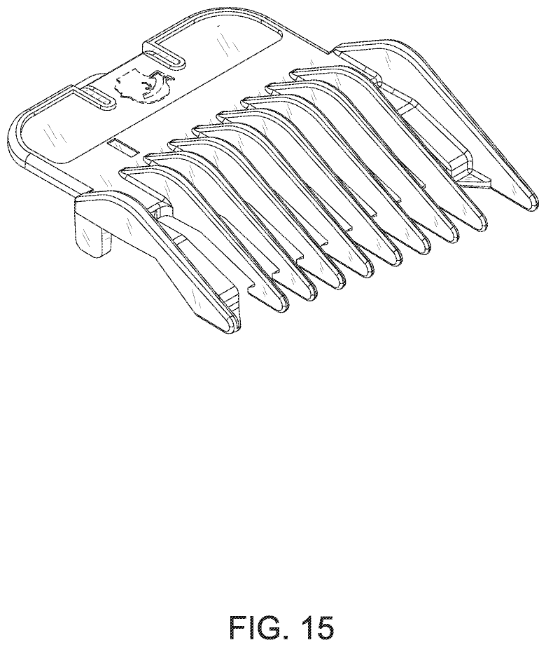

FIG. 16 is a third perspective view thereof.

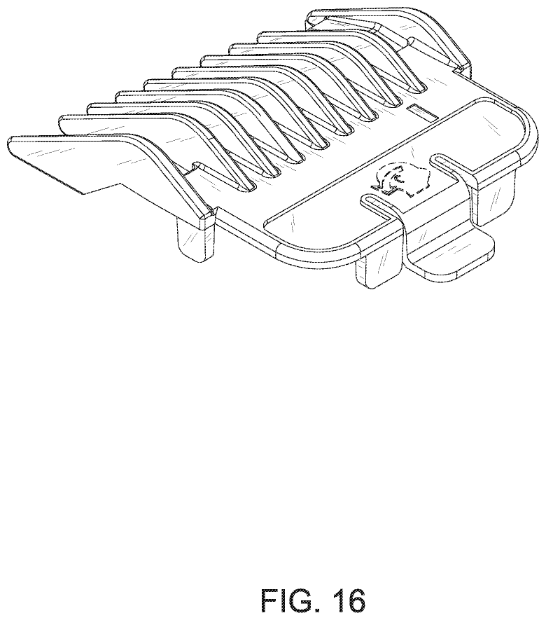

FIG. 17 is a fourth perspective view thereof.

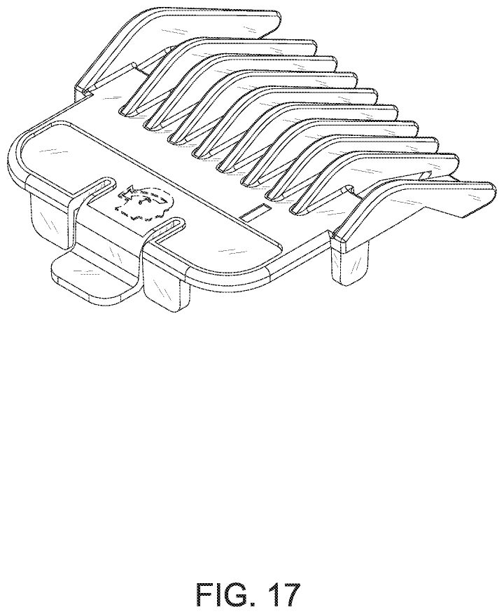

FIG. 18 is a fifth perspective view thereof.

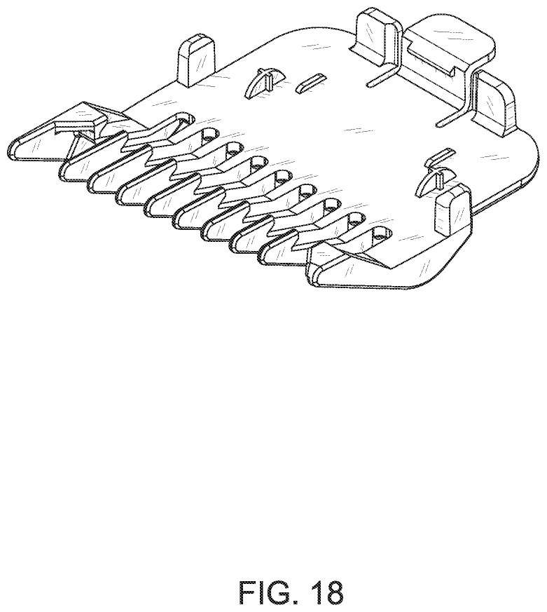

FIG. 19 is a sixth perspective view thereof.

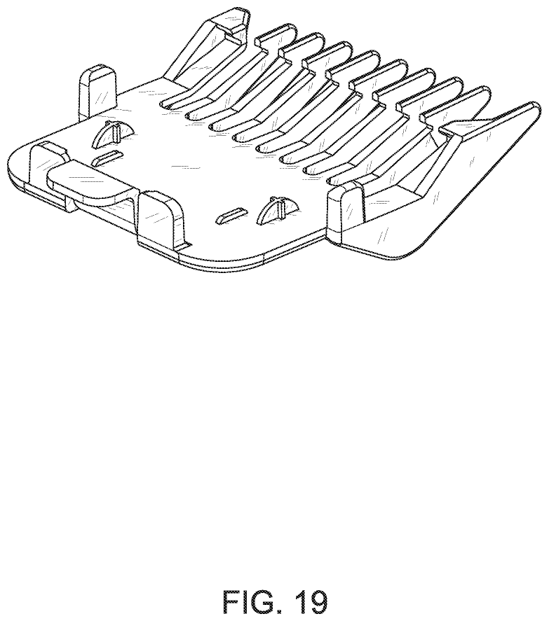

FIG. 20 is a front view thereof.

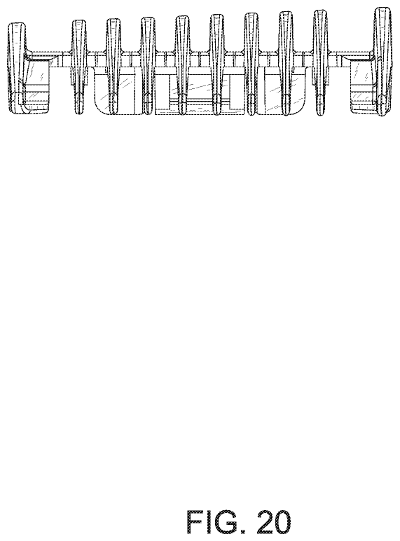

FIG. 21 is a rear view thereof.

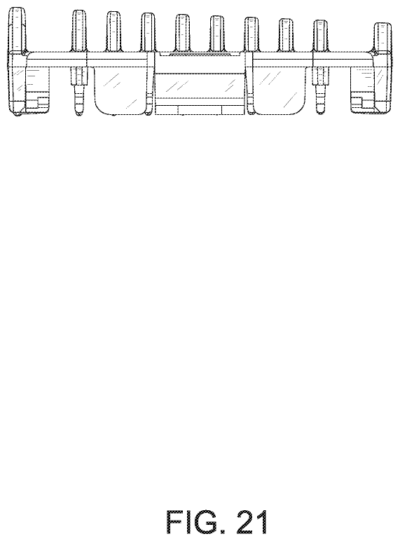

FIG. 22 is a right side view thereof.

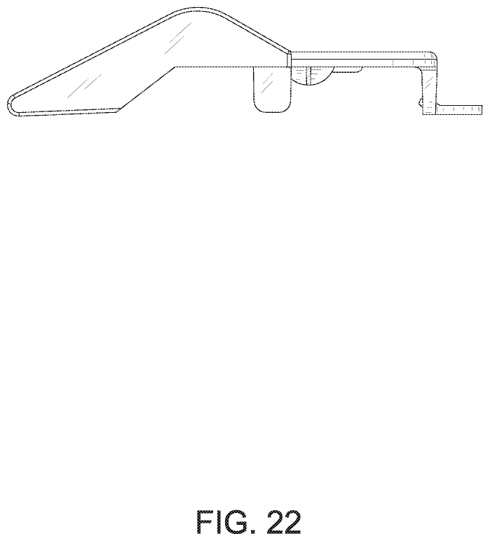

FIG. 23 is a left side view thereof

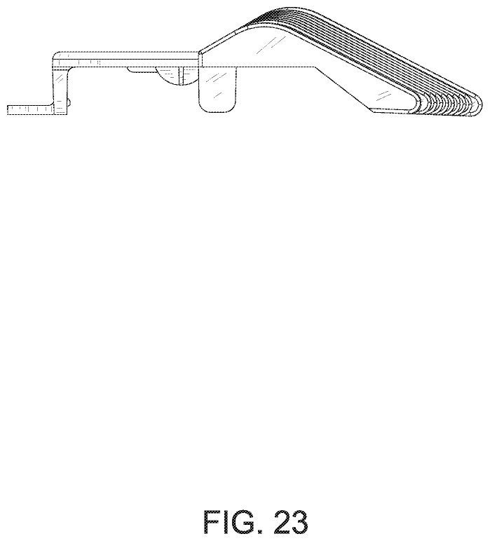

FIG. 24 is a top view thereof.

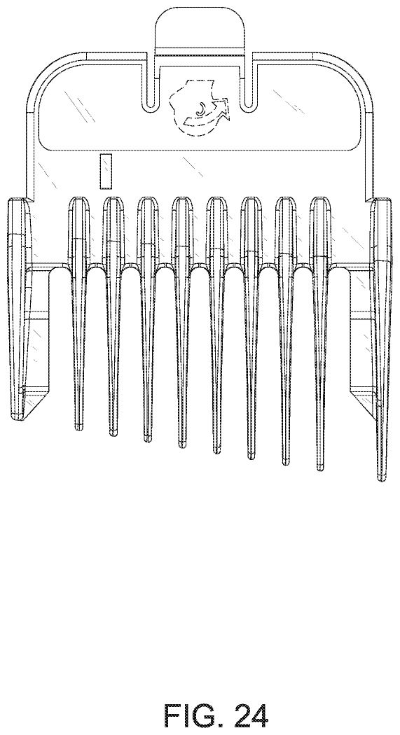

FIG. 25 is a bottom view thereof.

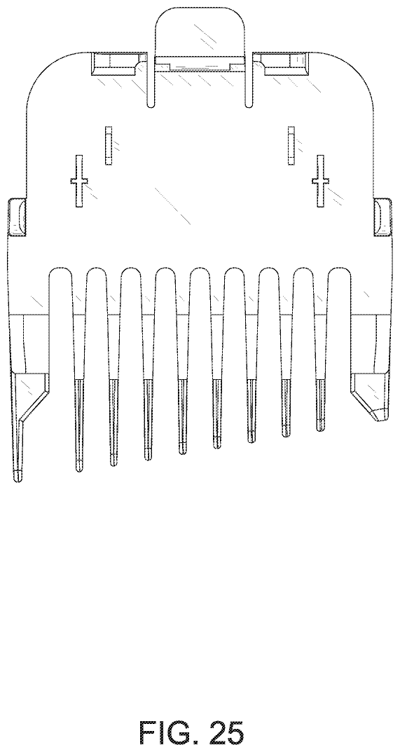

FIG. 26 is a first perspective view of a SECOND COMB showing the new design.

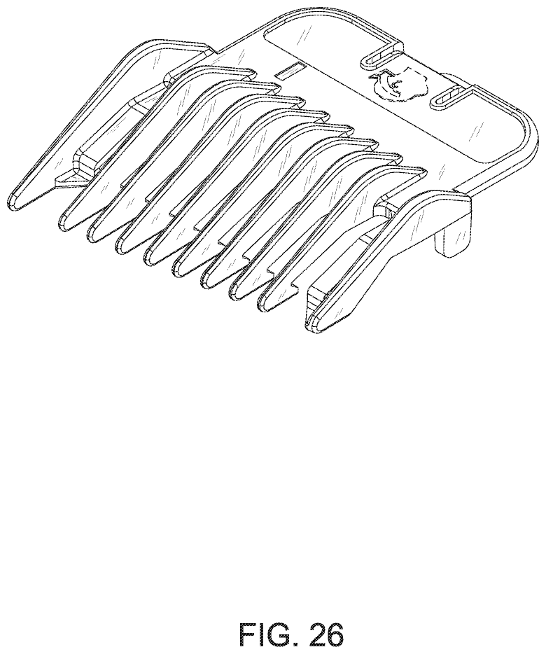

FIG. 27 is a second perspective view thereof.

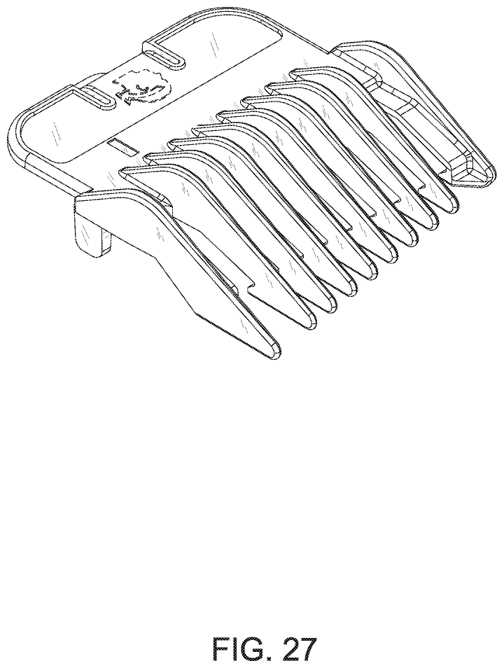

FIG. 28 is a third perspective view thereof.

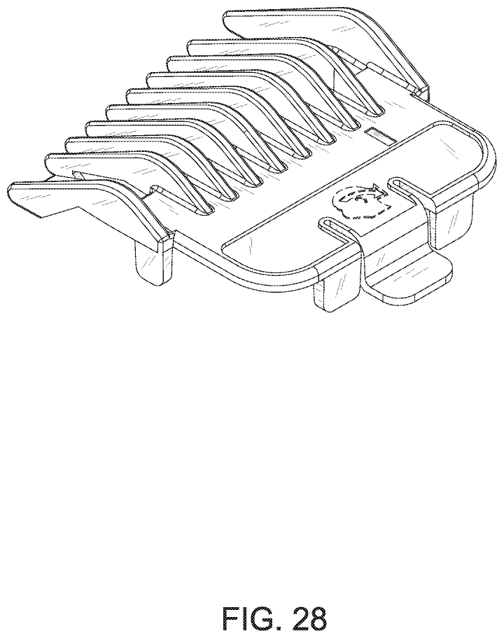

FIG. 29 is a fourth perspective view thereof.

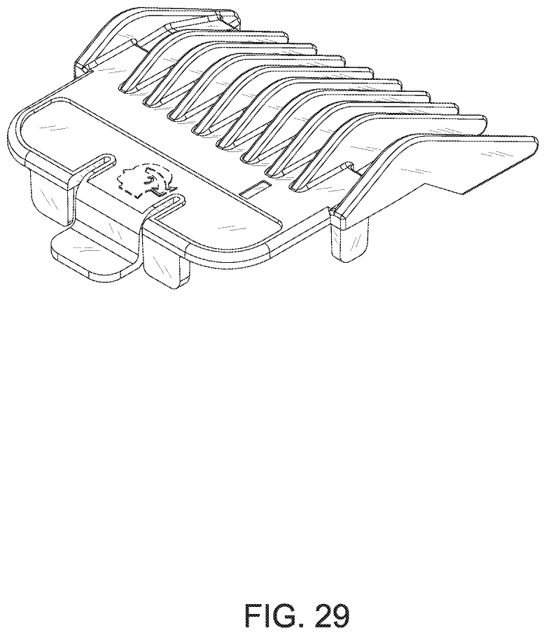

FIG. 30 is a fifth perspective view thereof.

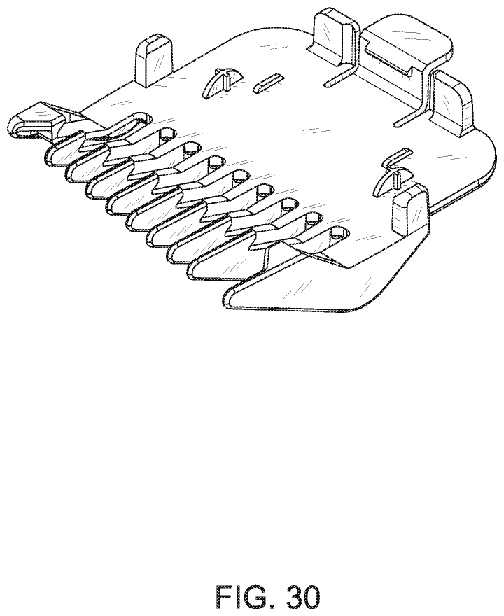

FIG. 31 is a sixth perspective view thereof.

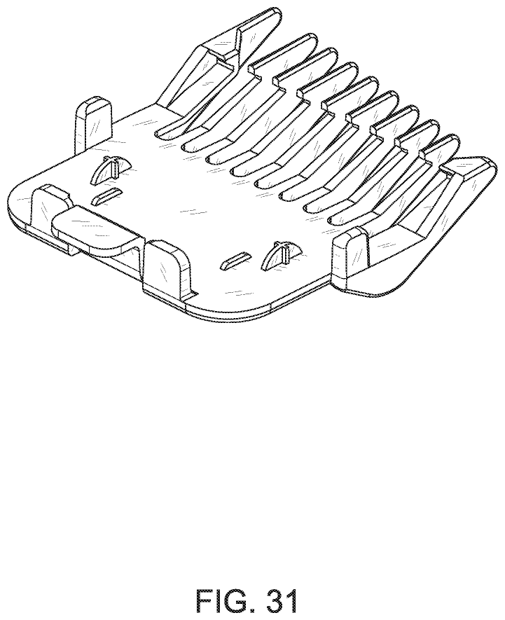

FIG. 32 is a front view thereof.

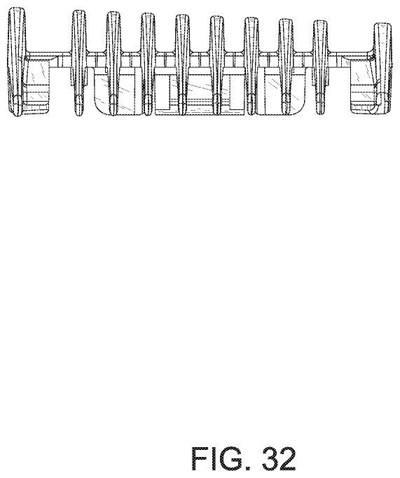

FIG. 33 is a rear view thereof.

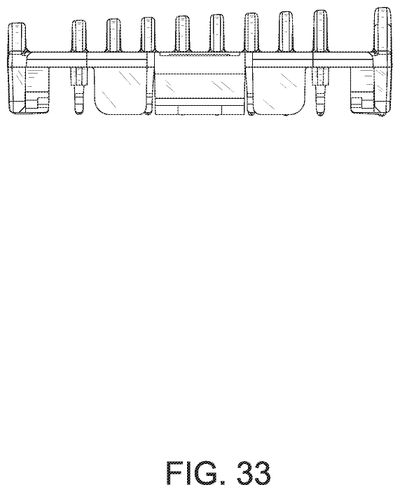

FIG. 34 is a right side view thereof.

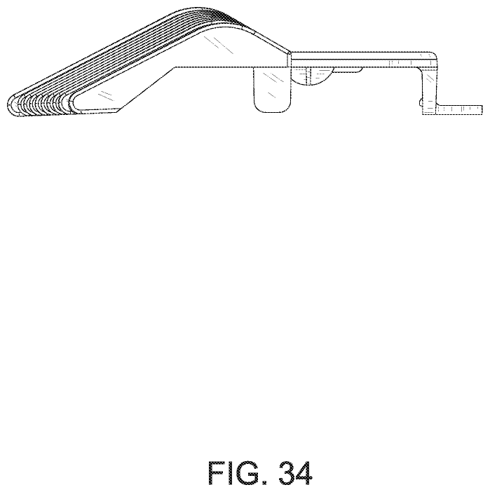

FIG. 35 is a left side view thereof

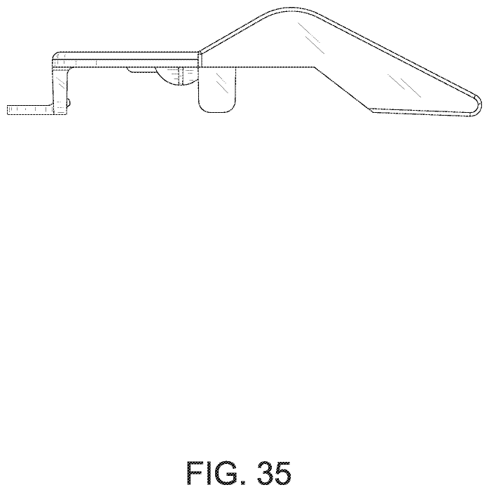

FIG. 36 is a top view thereof.

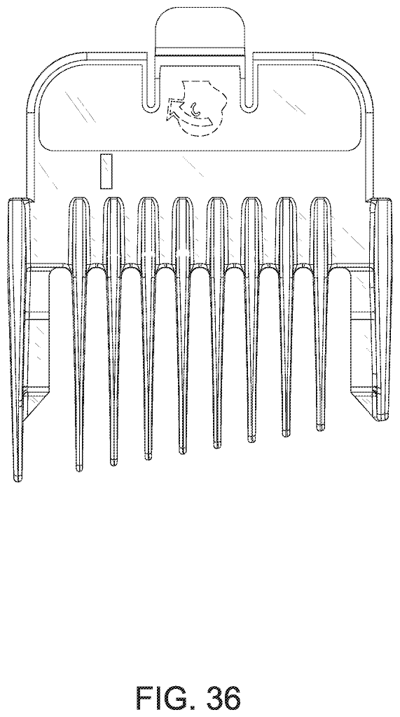

FIG. 37 is a bottom view thereof.

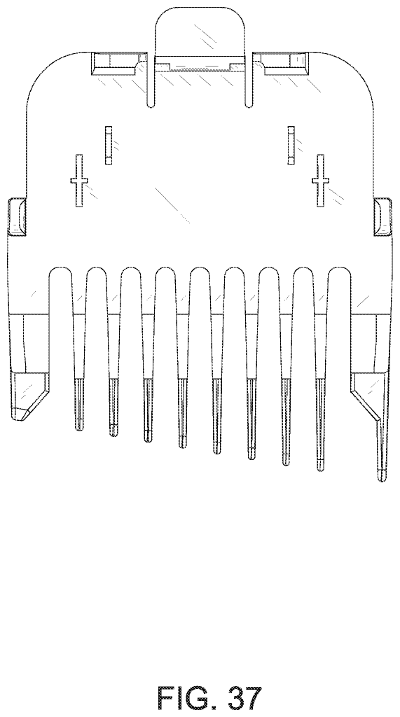

The ornamental design which is claimed is shown in solid lines in the drawings. Broken lines are for illustrative purposes only and form no part of the claimed design. Parallel thin lines and radial thin lines represent contours and do not illustrate an ornamentation or decoration.

We claim the ornamental design for a FADE COMB for use with an electric hair trimmer, as shown and described.

### DETAILED DESCRIPTION

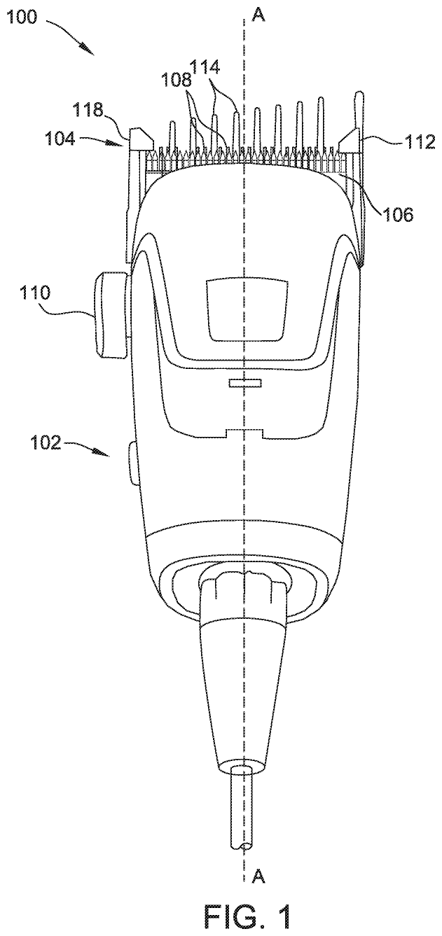

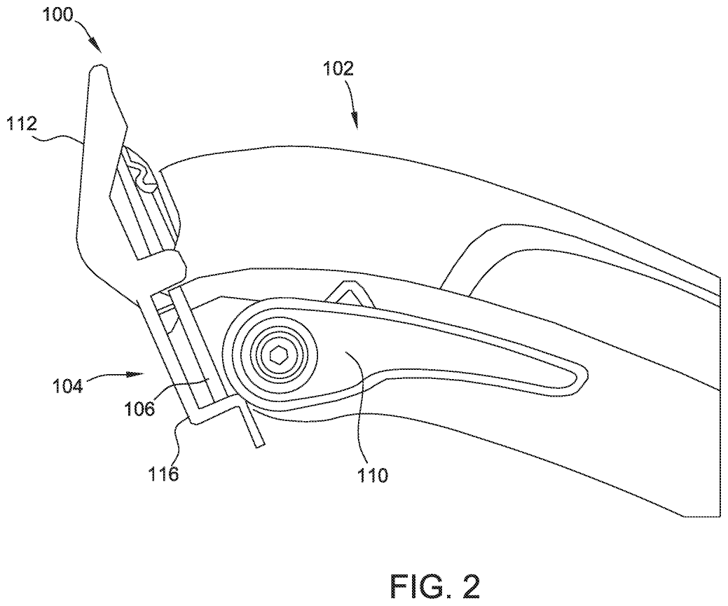

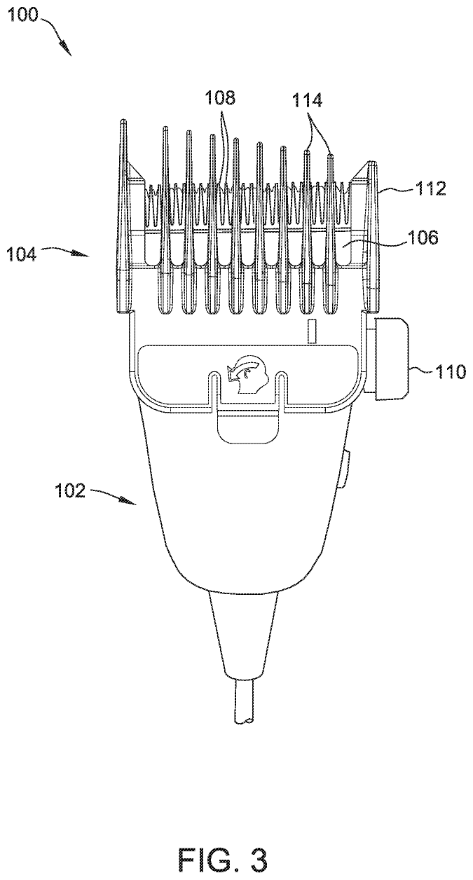

Referring now to the drawings, and in particular to FIGS. 1-3, a conventional electric hair trimmer (broadly, a grooming appliance) is indicated generally by 100. As illustrated in FIG. 1, the trimmer 100 defines a longitudinal axis A-A. The illustrated trimmer 100 comprises a handle (indicated generally by 102) defining an internal chamber (not shown), and a head (indicated generally by 104) located at a distal end of the handle. In the illustrated embodiment, the head 104 is selectively detachable from and reattachable to the handle 102. In other embodiments, however, the head 104 may not be detachable from the handle 102.

The head 104 of the trimmer 100 includes a blade assembly 106 having a plurality of blades 108. The plurality of blades 108 defines a blade edge 120. The head 104, including the blade assembly 106, is removably coupled to the handle 102. In the illustrated embodiment, the handle 102 includes a release mechanism, such as a release leaver 110. Actuation of the release leaver 110 facilitates removal of the blade assembly 106 from the handle 102. During operation of the trimmer 100, an electric motor (not shown) located within the internal chamber of the handle 102 causes at least one blade of the plurality of blades 108 to oscillate side to side via a drive mechanism.

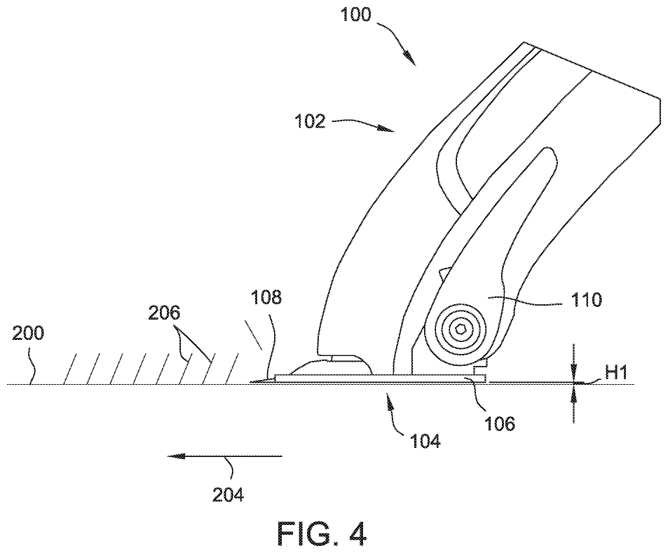

With reference to FIG. 4, the relative oscillation of the plurality of blades 108 cuts hair 206 as the trimmer 100 is moved in a cutting direction 204. As seen in FIG. 4, the trimmer 100 can be used to cut hair to a height H1. In the illustrated example, the height H1 is approximately equal to the distance between the plurality of blades 108 and a person's skin 200 when the trimmer 100 is moved along the person's skin 200 to cut the hair 206.

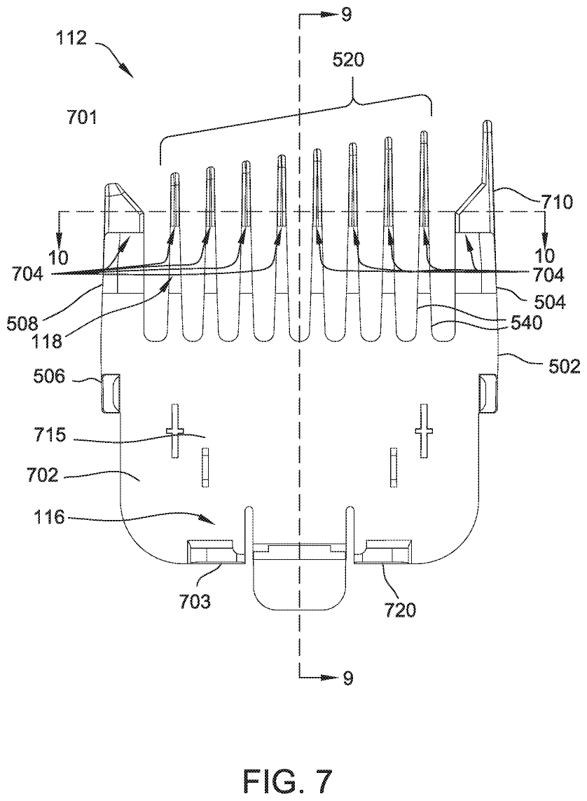

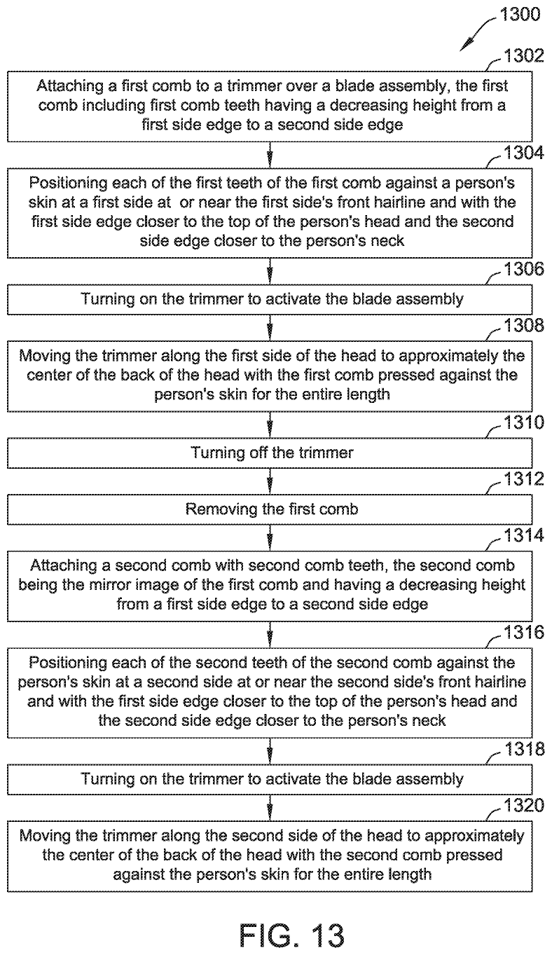

Referring back to FIGS. 1-3, the trimmer 100 seen therein further includes one suitable embodiment of a fade comb 112 of the present disclosure attached to the head 104. During operation of the trimmer 100, as described in more detail below with reference to FIG. 12, the fade comb 112 causes the plurality of blades 108 of the trimmer 100 to cut the hair 206 at a height greater than a cutting height H1 of the plurality of blades 108 without the fade comb 112 attached thereto. The fade comb 112 is selectively removeably engaged with the head 104. Thus, the fade comb 112 can be manually attached to and detached from the head 104 of the trimmer 100 by the user. The fade comb 112 includes a back blade engagement section 116 and a front blade engagement section 118 (described in further detail below with reference to FIGS. 7-9) to releasably engage the blade assembly 106.

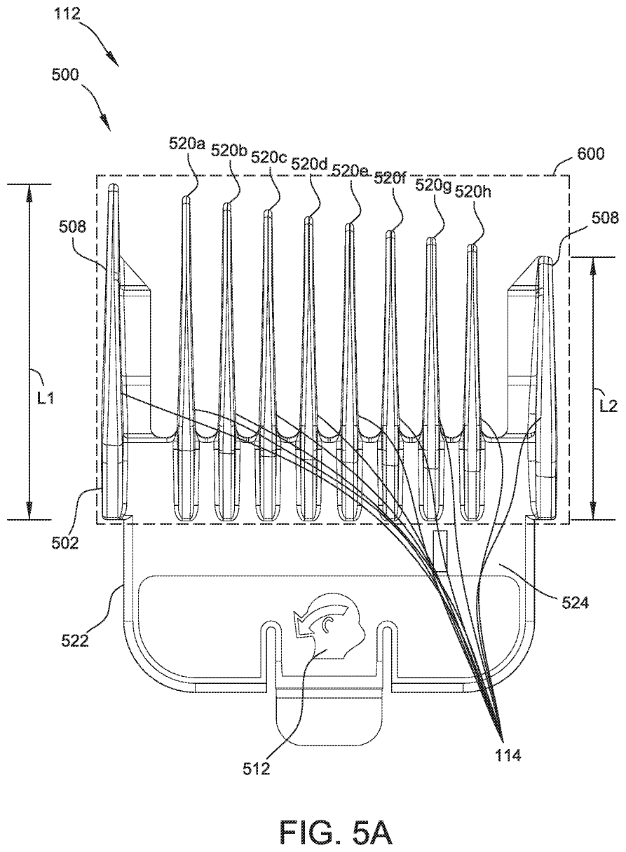

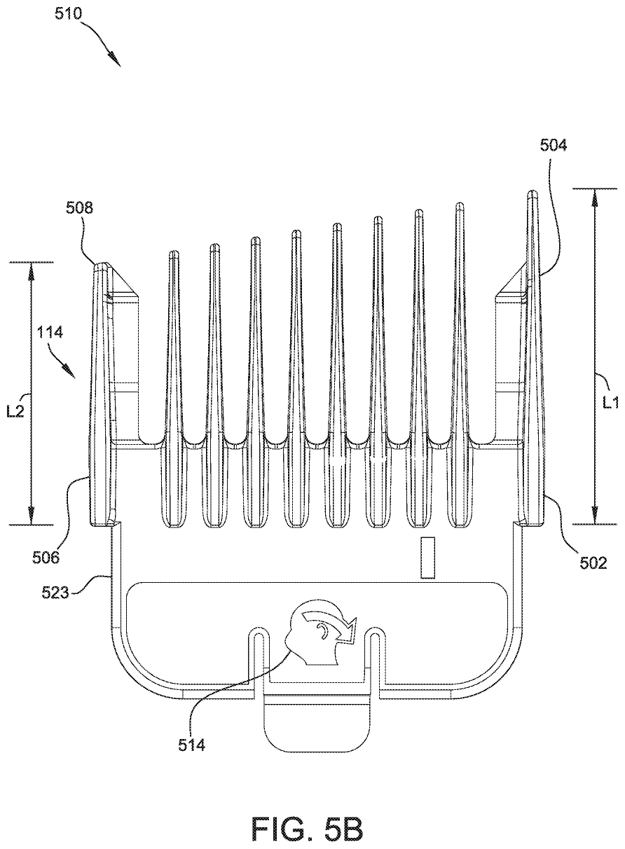

FIGS. 5A and 5B illustrate a pair of complementary fade combs 112 as shown from a skin-facing side 522. FIG. 5A shows a first fade comb 500 sized and shaped to provide a taper cut on a first side of a person's head when the trimmer 100 is moved in a first direction (i.e., a direction from the front of the person's head to the back of the head). In the illustrated embodiment, the first fade comb 500 is configured to cut hair in a tapered manner on the right side of the person's head.

FIG. 5B shows a second fade comb 510 sized and shaped to provide a taper cut on a second side of the person's head when the trimmer 100 is moved in the first direction (i.e., a direction from the front of the person's head to the back of the head). The second comb 510 is the mirror image of the first comb 500. In the illustrated embodiment, the second fade comb 510 is configured to cut hair in a tapered manner on the left side of the person's head. As a result, the first comb 500 and the second comb 510 are selectively attachable to and detachable from the trimmer 100 and allow for a gradient between different cutting lengths in the hair 206 on both the right and left sides of the person's head.

In the illustrated embodiment, the first comb 500 includes a first instructional image 512 and the second comb includes a second instructional image 514. Each of the instructional images 512, 514 indicates the side (i.e., right or left) of the head and the direction the respective comb 500, 510 is intended to be moved along the head. As shown by the first instructional image 512, the first comb 500 is intended to be used on the right side of a person's head, and as shown by second instructional image 514, the second comb 510 is intended to be used on the left side of a person's head.

Because the first comb 500 and the second comb 510 are mirror images of each other, the description of the first comb 500 applies to the second comb 510, unless otherwise specified.

With reference to FIGS. 5A-9, the fade comb 112 includes a back 703, a front 701, a first side edge 502, and a second side edge 506. The first side edge 502 and the second side edge 506 each extend from the back 703 to the front 701. The comb 112 also includes the skin-facing side 522 (mentioned above) and an opposing blade-facing side 702. The blade-facing side 702 faces the blade assembly 106 when the comb 112 is attached to the trimmer 100 and includes a planar blade-abutting portion 715 defined between the back 703 and the two opposing side edges 502, 506. The skin-facing side 522 of the comb 112 faces the person's skin during operation of the trimmer 100. The skin-facing side 522 includes a skin-facing surface 524 that is substantially planar. In alternative embodiments, the skin-facing surface 524 may be non-planar.

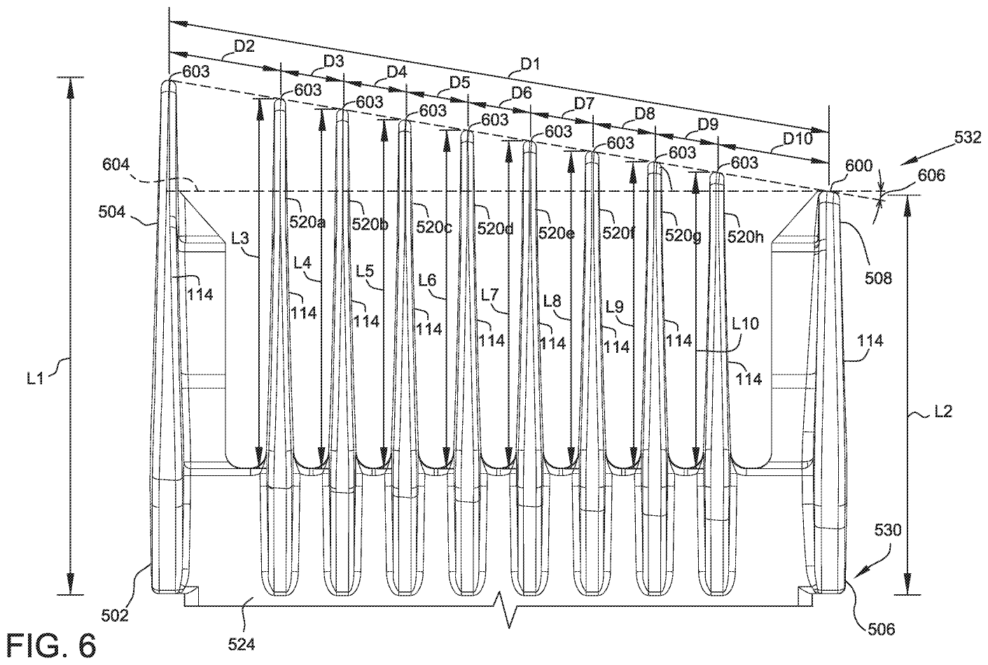

FIG. 6 is an enlarged view of the area 600 of the fade comb 112 indicated in FIG. 5A. The teeth 114 of the fade comb 112 include a first outer tooth 504 extending at or adjacent the first side edge 502 of the first comb 500, a second outer tooth 508 extending at or adjacent the second side edge 506, and intermediate teeth 520 arranged between the first outer tooth 504 and the second outer tooth 508. As illustrated in FIG. 5A, the first fade comb 500 includes eight of the intermediate teeth 520, designated comb teeth 520a-h with the first intermediate tooth 520a adjacent the first outer tooth 504 and the eighth intermediate tooth 520h adjacent the second outer tooth 508. It will be appreciated, however, that the comb 500 may include more or less than eight intermediate teeth 520 without departing from some aspects of this disclosure.

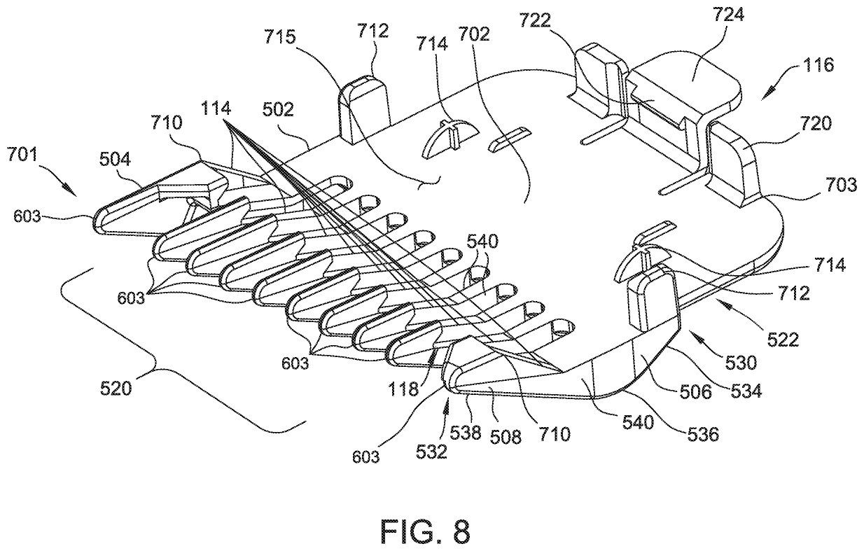

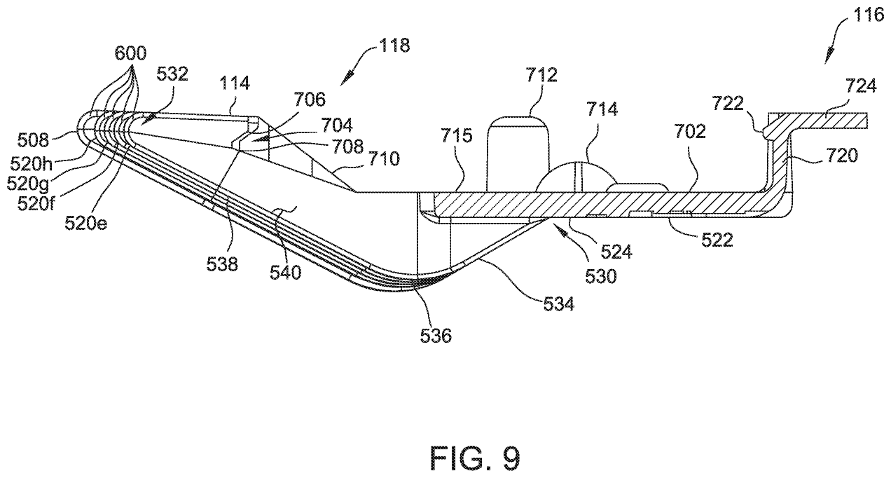

As best seen in FIGS. 8 and 9, on the skin-facing side 522, each tooth 114 has a proximal end 530 extending outward and forward from the skin-facing surface 524 of the skin-facing side 522, a distal end 532 at the front 701, and tooth sides 540 therebetween. Each tooth 114 also includes a curved transition portion 534 between the proximal end 530 and the distal end 532, an apex 536 within the curved transition portion 534, and a skin-contacting edge 538 between the curved transition portion 534 and the distal end 532. The apex 536 represents the outermost point of each tooth 114 relative to the skin-facing surface 524. The skin-contacting edge 538 represents the portion of the comb 112 that contacts the person's skin 200 during operation of the trimmer 100. Each tooth 114 has a substantially curved, or bowed, shape from the proximal end 530 to the distal end 532. More specifically, at the proximal end 530, each tooth 114 extends approximately linearly outward from skin-facing surface 524 to the curved portion 534. At the curved portion 534, each tooth 114 curves inwards to the apex 536 and continues to curve inward from the apex 536 throughout the remainder of the curved portion 534. The skin-contacting edge 538 is substantially linear between the curved portion 534 and the distal end 532 to a tip 603.

With reference still to FIGS. 6, 8, and 9, each tooth 114 has the tip 603 at the distal end 532. The tip 603 of each of the teeth 114 has a substantially curved, or rounded, shape. In other suitable embodiments, the tip 603 may have any shape that allows the fade comb 112 to function as described herein, such as a triangular or rhombus shape. During operation of the trimmer 100, the tip 603 of each of the teeth 114 is the first point of contact with the hair 206 as the teeth 114 separate the hair 206 when the fade comb 112 traverses along or adjacent the person's skin 200 during the hair cutting operation.

As best seen in FIG. 6, each tooth 114 has a length L as measured from the tip 603 to the proximal end 530. The first outer tooth 504 has a first length L1, the second outer tooth 508 has a second length L2, and each of each intermediate tooth 520a has a length L3-L10. The first length L1 is greater than the second length L2 and the lengths L3-L10. Also, the lengths L3-L10 decrease from the first side edge 502 to the second side edge 506 and the second length L2 is shorter than the lengths L3-L10. Accordingly, each tooth 520a-h of the plurality of intermediate teeth 520 has a length L3-L10, respectively, less than the first length L1 and greater than the second length L2. More specifically, the first intermediate tooth 520a has a third length L3 that is greater than a fourth length L4 of the second intermediate tooth 520b. The fourth length L4 is greater than a fifth length L5 of the third intermediate tooth 520c. The fifth length L5 is greater than a sixth length L6 of the fourth intermediate tooth 520d. The sixth length L6 is greater than a seventh length L7 of the fifth intermediate tooth 520e. The seventh length L7 is greater than an eighth length L8 of the sixth intermediate tooth 520f. The eighth length L8 is greater than a ninth length L9 of the seventh intermediate tooth 520g. The ninth length L9 is greater than a tenth length L10 of the eighth intermediate tooth 520h.

Still referring to FIG. 6, the teeth 114 define an overall first distance D1 from the first outer tooth 504 at or adjacent the first side edge 502 to the second outer tooth 508 at or adjacent the second side edge 506. From the first side edge 502 to the second side edge 506, the teeth 114 are spaced apart distances D2, D3, D4, D5, D6, D7, D8, D9, and D10. Specifically, the first outer tooth 504 and the first intermediate tooth 520a define a second distance D2, the intermediate teeth 520b-520h define distances D3-D9, and the eighth intermediate tooth 520h and the second outer tooth 508 define a tenth distance D10. In one suitable embodiment, the second distance D2 is approximately equal to the tenth distance. Similarly, the third distance D3 through the ninth distance D9 (i.e., the distances between each adjacent intermediate tooth 520a-h) are approximately equal to each other. In other suitable embodiments, the distances D2-D10 are any distances that allow the trimmer to function as described herein. For example, in some embodiments, adjacent teeth are spaced apart distances that are not equal to the distance between other teeth.

With further reference to FIG. 6, a comb-tip line 602 (or slope of the fade comb 112) is defined by the outer most extent of the tips 603 of the teeth 114. For example, the comb-tip line 602 extends to the tip 603 of the first outer tooth 504 and the tip 603 of the second outer tooth 508. The orientation of the comb-tip line 602 is dictated by the lengths L1-L10 and the distances D2-10 between each of the teeth 114. In the exemplary embodiment seen in FIG. 6, the tips 603 of each of the intermediate teeth 520 also define the comb-tip line 602. However, in other suitable embodiments, the comb-tip line 602 can extend through some or none of the tips 603 of the intermediate teeth 520. The comb-tip line 602 and a reference line 604 define an angle 606. The reference line 604 is the shortest distance between the tip 603 of the second outer tooth 508 and the first outer tooth 504.

With reference now to FIGS. 7-9, the blade-facing side 702 of the fade comb 112 includes the back blade engagement section 116 and the front blade engagement section 118. The front blade engagement section 118 is situated at the front 701 of the fade comb 112. The front blade engagement section 118 includes a slot 704 defined within each of the teeth 114. The slot 704 is configured to receive the plurality of blades 108. Each tooth 114 includes an overhang region 706 and a base region 708 (best seen in FIG. 9). The overhang region 706 and the base region 708 define the slot 704 therebetween. If a blade assembly 106 is inserted into the slot 704, the overhang region 706 extends over the plurality of blades 108, while the base region 708 is situated beneath the plurality of blades 108. The first outer tooth 504 and the second outer tooth 508 each include a front side guard 710 to prevent forward and side movement of the comb 112 when the blade assembly 106 is inserted into the slot 704.

The back blade engagement section 116 includes a rear guard 720 extending adjacent the back 703 of the blade-facing side 702. The rear guard includes a latch 722 and a tab 724. The rear guard 720 prevents rearward movement by the comb 112 when the blade assembly 106 is inserted into the slot 704. The latch 722 extends from the rear guard 720 towards the front 701. The latch 722 is configured to engage a portion of the blade assembly 106 to lock the comb 112 to the blade assembly 106. In other suitable embodiments, the latch 722 may engage the handle 102 or another portion of the head 104 of the trimmer 100. The tab 724 extends rearwardly away from the latch 722 and is configured to assist the user in disengaging the latch 722 from its locked position, allowing removal of the comb from the trimmer 100.

The planar blade-abutting portion 715 of the blade-facing side 702 includes mid side guards 712 and spacers 714. The mid side guards 712 are situated at or adjacent the first side edge 502 and the second side edge 506 to prevent side movement of the comb 112 when the blade assembly 106 is inserted into the slot 704. In the exemplary embodiment, a single mid side guard 712 is located on each of the opposing side edges 502, 506. In other suitable embodiments, the comb 112 may have more, fewer, or no mid side guards 712. The spacers 714 abut the blade assembly 106 when the blade assembly 106 is inserted into the slots 704. The spacers 714 prevent contact of the entire planar blade-abutting portion 715 with the blade assembly 106. In the illustrated embodiment, the comb 112 has two spacers 714, but in alternative embodiments, the comb 112 has more, fewer, or no spacers 714.

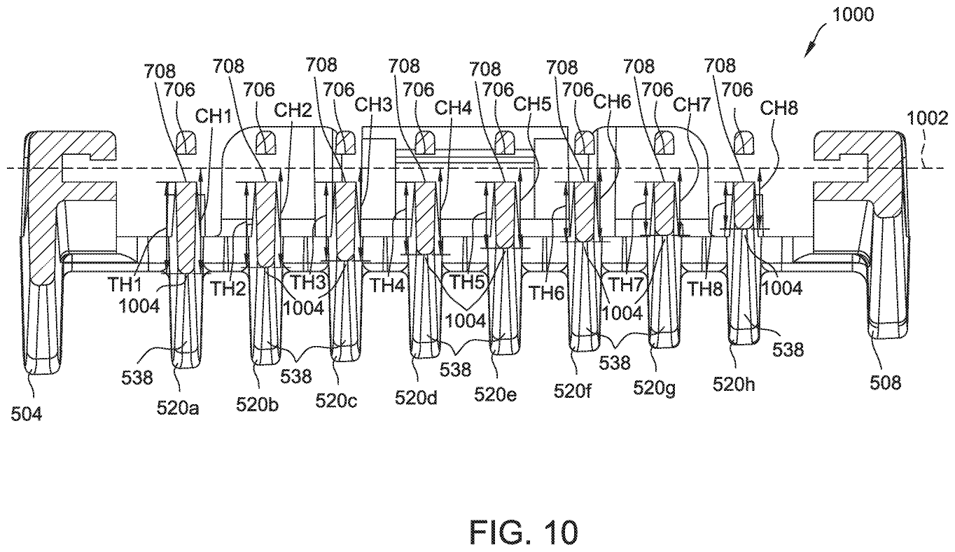

FIG. 10 shows a cross-sectional view of the comb 112 taken across line 10-10, which represents a plane 1000 of the comb 112. The plane 1000 extends along the blade edge 120 of a blade assembly 106 received by the comb 112. More specifically, line 10-10 represents the forward-most position that the plurality of blades 108 extends to while the blade assembly 106 is situated within slot 704. The plane 1000 bisects the teeth 114 of the comb 112 and extends through the slot 704. The plane 1000 is perpendicular to the planar blade-abutting portion 715. With reference to FIG. 10, a cutting line 1002 represents the positioning of the blades 108 between the overhang region 706 and the base region 708 for each of the teeth 114 when the blade assembly 106 is situated within the slot 704.

Each intermediate tooth 520a-h of the comb 112 has a tooth height TH1-8 at the plane 1000. The tooth height TH1-8 of each of the intermediate teeth 520 is the height of the intermediate tooth 520a-h as measured from the base region 708 to an outermost point 1004 of the skin-contacting edge 538 within cutting plane 1000. As shown in FIG. 10, the first tooth height TH1 of the first intermediate tooth 520a is greater than the second tooth height TH2 of the second intermediate tooth 520b. The second tooth height TH2 of the second intermediate tooth 520b is greater than the third tooth height TH3 of the third intermediate tooth 520c. The third tooth height TH3 of the third intermediate tooth 520c is greater than the fourth tooth height TH4 of the fourth intermediate tooth 520d. The fourth tooth height TH4 of the fourth intermediate tooth 520d is greater than the fifth tooth height TH5 of the fifth intermediate tooth 520e. The fifth tooth height TH5 of the fifth intermediate tooth 520e is greater than the sixth tooth height TH6 of the sixth intermediate tooth 520f. The sixth tooth height TH6 of the sixth intermediate tooth 520f is greater than the seventh tooth height TH7 of the seventh intermediate tooth 520g. The seventh tooth height TH7 of the seventh intermediate tooth 520g is greater than the eighth tooth height TH8 of the eighth intermediate tooth 520h.

Each of the intermediate teeth 520 provide a cutting height CH1-8 when the trimmer 100 (shown in FIG. 1) is moved a long a skin surface and used to cut hairs protruding from the skin. The cutting height CH1-8 is the shortest distance between the cutting line 1002 and the outermost point 1004 of the skin-contacting edge 538 within the cutting plane 1000. As shown in FIG. 10, the first cutting height CH1 of the first intermediate tooth 520a is greater than the second cutting height CH2 of the second intermediate tooth 520b. The second cutting height CH2 of the second intermediate tooth 520b is greater than the third cutting height CH3 of the third intermediate tooth 520c. The third cutting height CH3 of the third intermediate tooth 520c is greater than the fourth cutting height CH4 of the fourth intermediate tooth 520d. The fourth cutting height CH4 of the fourth intermediate tooth 520d is greater than the fifth cutting height CH5 of the fifth intermediate tooth 520e. The fifth cutting height CH5 of the fifth intermediate tooth 520e is greater than the sixth cutting height CH6 of the sixth intermediate tooth 520f. The sixth cutting height CH6 of the sixth intermediate tooth 520f is greater than the seventh cutting height CH7 of the seventh intermediate tooth 520g. The seventh cutting height CH7 of the seventh intermediate tooth 520g is greater than the eighth cutting height CH8 of the eighth intermediate tooth 520h.

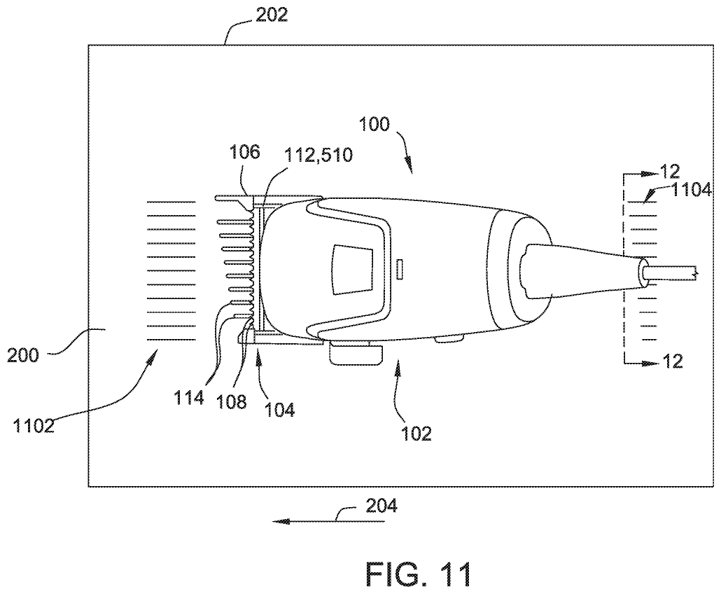

FIG. 11 schematically illustrates the trimmer 100 with the second comb 510 attached thereto being passed along the person's skin 200 to cut hairs 1102. FIG. 12 is a cross-sectional view of the skin taken along line 12-12. As the trimmer 100 passes along the person's skin 200 in the cutting direction 204, the blades 108 cut untrimmed hair, shown as a single row of untrimmed hair 1102, creating trimmed hair, shown as a single row of trimmed hair 1104. As best seen in FIG. 12, the differing tooth heights TH1-8 and cutting heights CH1-8 of the teeth 114 produce trimmed hair 1104 having a fade cut 1200. More specifically, the differing tooth heights TH1-8 and cutting heights CH1-8 produce a fade cut 1200 having an approximately proportional cutting gradient 1202 from a first cut hair end 1204 having a second height H2 to a second cut hair end 1206 having a third height H3 less than second height H2.

The comb 112 described herein may have varying dimensions to produce a desired fade cut 1200 having a desired second height H2 and third height H3. For example, in the illustrated embodiment, the comb 112 is a 3-6 mm fade comb. In alternative embodiments, the comb 112 may have a different configuration to allow for a fade cut 1200 having a cutting gradient 1202 and varying second and third heights H2 and H3. For example, the comb 112 may be a 1.5-3 mm fade comb, a 6-9 mm fade comb, a 9-12 mm fade comb, or a 12-16 mm fade comb. In still further embodiments, the comb 112 may have any tooth heights TH1-8 and cutting heights CH1-8 that allows the comb 112 and trimmer 100 to function as described herein.

In an embodiment, one or more teeth 114 is adjustable such that one or more of the tooth heights TH1-8 and one or more of the cutting heights CH1-8 can be changed. For example, a comb may be set to produce a 3-6 mm fade cut, then one or more of the teeth 114 may be adjusted to produce a 3-8 mm fade cut. In such embodiments, the teeth 114 maybe be locked into each position between each adjustment. In still further embodiment, the distance between the teeth 114 and the blade assembly 106 is adjustable. For example the trimmer 100 and/or the comb 112 may include an adjustment mechanism that allows the position of the comb relative to the trimmer to be adjusted to change cut height of the comb. Accordingly, a single fade comb 112 may be used for multiple different fade cut lengths.

In an embodiment, the fade comb 112 having teeth heights TH1-8 attaches to a uniform comb having teeth of uniform heights. The uniform comb is attached to the blade assembly 106 and receives the blades 108. The combination of the uniform heights and the teeth heights TH1-8 creates desired fade cut 1200. In some such embodiments, the fade comb 112 is configured to attach only to the uniform comb. In alternative embodiments, the fade comb 112 is configured to attach to either the uniform comb or the blade assembly 106, or both.

In an embodiment, a comb kit includes a plurality of combs 112. The plurality of combs 112 includes at least two different sized combs 112 configured to generate two different fade cuts 1200 having different second and third heights H2 and H3. Specifically, in an embodiment, the comb kit includes at least two of (i) a 1.5-3 mm fade comb, (ii) a 3-6 mm fade comb, (iii) a 6-9 mm fade comb, (iv) a 9-12 mm fade comb, and (v) a 12-16 mm fade comb. Each size of comb 112 includes a first fade comb 500 and a second fade comb 510 (i.e. a right and left comb).

In an embodiment, a trimmer kit includes a trimmer 100 and at least one comb 112. Specifically, in an embodiment, the trimmer kit includes the trimmer 100 and at least one pair of complementary first and second fade combs 500, 510 (i.e. a right and left comb). The trimmer kit allows the user to cut the person's hair 206 on the right side and left side of the person's head. In alternative embodiments, the trimmer kit includes the trimmer and the comb kit.

In the embodiment where the comb 112 is a 3-6 mm fade comb, the angle 606 is about 0 degrees to about 45 degrees. In further embodiments, the angle 606 is about 2 degrees to about 15 degrees. In still further embodiments, the angle 606 is approximately 10 degrees. Additionally, in an embodiment of the 3-6 mm fade comb, the first distance D1 is about 35 mm to about 75 mm. In further embodiments, the first distance D1 is about 46 mm to about 50 mm. In some examples of the 3-6 mm fade comb, the second distance D2 and the tenth distance D10 are about 5 mm to about 13 mm, and, more specifically, about 7 mm to about 9 mm. Additionally, the third distance D3 through the ninth distance D9 of the 3-6 mm fade comb are about 3 mm to about 10 mm and, more specifically, about 4 mm to about 6 mm.

In an embodiment of the 3-6 mm fade comb, the first length L1 is from about 36 mm to about 39 mm, the second length L2 is from about 27 mm to about 30 mm, the third length L3 is from about 26 mm to about 28 mm, the fourth length L4 is from about 25 mm to about 27 mm, the fifth length L5 is from about 24 mm to about 26 mm, the sixth length L6 is from about 23 mm to about 25 mm, the seventh length L7 is from about 22 mm to about 24 mm, the eighth length L8 is from about 22 mm to about 24 mm, the ninth length L9 is from about 21 mm to about 23 mm, and the tenth length L10 is from about 20 mm to about 22 mm.

In an embodiment of the 3-6 mm fade comb, the first tooth height TH1 is from about 4.2 mm to about 4.6 mm, the second tooth height TH2 is from about 3.8 mm to about 4.2 mm, the third tooth height TH3 is from about 3.4 mm to about 3.8 mm, the fourth tooth height TH4 is from about 3.1 mm to about 3.5 mm, the fifth tooth height TH5 is from about 2.8 mm to about 3.2 mm, the sixth tooth height TH6 is from about 2.4 mm to about 2.8 mm, the seventh tooth height TH7 is about 2.1 mm to about 2.5 mm, and the eighth tooth height TH8 is from about 1.7 mm to about 2.1 mm.

In an embodiment, a ratio between the first tooth height TH1 and the second tooth height TH2 is about 1:70 to about 3:16. In further embodiments, the first ratio between the first tooth height TH1 and the second tooth height TH2 is approximately 3:46. In some embodiments, the ratio between each adjacent tooth height TH2-TH8 is the same as the ratio the first tooth height TH1 and the second tooth height TH2. In other embodiments, the ratio between each adjacent tooth height TH1-TH8 varies such that one or more of the ratios are not the same. In still further embodiments, the ratio between each adjacent tooth height TH1-TH8 decreases from one side to another. For example, the first ratio between the first tooth height TH1 and the second tooth height TH2 is greater than the second ratio between the second tooth height TH2 and the third tooth height TH3, which is greater than the third ratio between the third tooth height TH3 and the fourth tooth height TH4.

In an embodiment of the 3-6 mm fade comb, the first cutting height CH1 is about 5.2 mm to about 5.6 mm, the second cutting height CH2 is about 4.8 mm to about 5.2 mm, the third cutting height CH3 is about 4.4 mm to about 4.8 mm, the fourth cutting height CH4 is about 4.1 mm to about 4.5 mm, the fifth cutting height CH5 is about 3.8 mm to about 4.2 mm, the sixth cutting height CH6 is about 3.4 mm to about 3.8 mm, the seventh cutting height CH7 is about 3.1 mm to about 3.5 mm, and the eighth cutting height CH8 is about 2.7 mm to about 3.1 mm.

In an embodiment, a ratio between the first cutting height CH1 and the second cutting height CH2 is about 1:70 to about 3:16. In further embodiments, the first ratio between the first cutting height CH1 and the second cutting height CH2 is approximately 3:46. In some embodiments, the ratio between each adjacent cutting height CH2-CH8 is the same as the ratio the first tooth height CH1 and the second tooth height CH2. In other embodiments, the ratio between each adjacent cutting height CH1-CH8 varies such that one or more of the ratios are not the same. In still further embodiments, the ratio between each adjacent tooth height CH1-CH8 decreases from one side to another. For example, the first ratio between the first cutting height CH1 and the second cutting height CH2 is greater than the second ratio between the second cutting height CH2 and the third cutting height CH3, which is greater than the third ratio between the third cutting height CH3 and the fourth cutting height CH4.

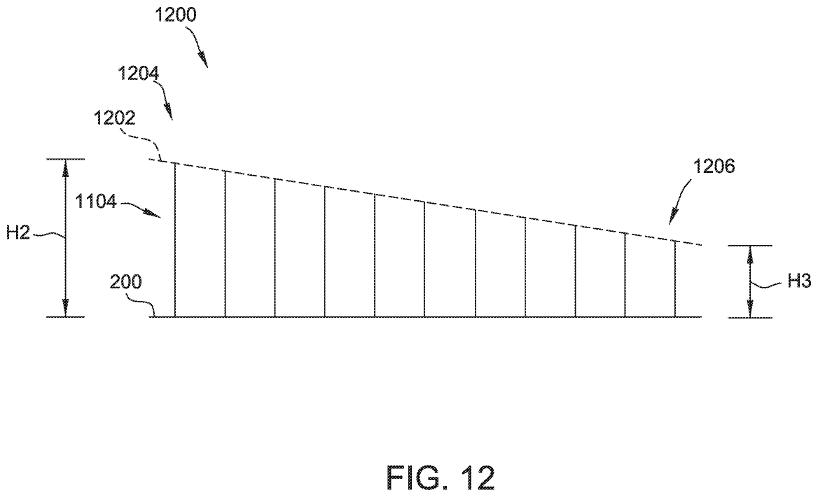

FIG. 13 is a flow diagram of one suitable method 1300 of creating a fade cut, such as the fade cut 1200, in a person's hair using an electric hair trimmer, such as the trimmer 100, and a comb, such as the comb 112. The method 1300 includes attaching 1302 a first comb, such as the first comb 500, to the trimmer over a blade assembly, such as the blade assembly 106. The first comb has first comb teeth, such as the teeth 114, having decreasing height from a first side edge, such as the first side edge 502, to a second side edge, such as the second side edge 506.

The method 1300 also includes positioning 1304 each of the first teeth of the first comb against the person's skin at a first side at or near the first side's front hairline and with the first side edge closer to the top of the person's head and the second side edge closer to the person's neck. The method 1300 additionally includes turning on 1306 the trimmer to activate the blade assembly and moving 1308 the trimmer along the first side of the head to approximately the center of the back of the head with the first comb pressed against the person's skin for the entire length.

The method 1300 further includes turning off 1310 the trimmer, removing 1312 the first comb, and attaching 1314 the second comb, such as the second comb 510. The second comb is the mirror image of the first comb and also has a decreasing height from a first side edge to a second side edge. The method 1300 also include positioning 1316 each of the second teeth of the second comb against the person's skin at a second side at or near the second side's front hairline and with the first side edge closer to the top of the person's head and the second side edge closer to the person's neck. The method 1300 additionally includes turning on 1318 the trimmer to activate the blade assembly and moving 1320 the trimmer along the second side of the head to approximately the center of the back of the head with the second comb pressed against the person's skin for the entire length. In further embodiments, the method 1300 may include attaching multiple combs having different cutting lengths to create multiple fades. For example, the method 1300 may include creating a first fade using a 3-6 mm fade comb near the person's neck and creating a second fade above the first fade (i.e. closer to the top of the person's hair) using a 6-9 mm fade comb.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A comb for an electric trimmer, the comb comprising:
a skin-facing side including a skin-facing surface;
a blade-facing side including a planar blade-abutting surface;
teeth projecting from the skin-facing surface and the planar blade-abutting surface, the teeth including a first outer tooth, a second outer tooth, and intermediate teeth, the intermediate teeth are spaced apart from each other and positioned between the first outer tooth and the second outer tooth, the intermediate teeth including a first intermediate tooth and a second intermediate tooth, each of the teeth comprising:
a proximal end adjacent the skin-facing surface;
a distal end;
a skin-contacting edge between the proximal end and the distal end; and
a base region located on the blade-facing side,
wherein each intermediate tooth defines a tooth height, the tooth height for each of the intermediate teeth representing the shortest distance between the base region and an outer-most point on the skin-contacting edge of each of the intermediate teeth, and
wherein a first tooth height defined by the first intermediate tooth is greater than a second tooth height defined by the second intermediate tooth, and wherein a first ratio between the first tooth height and the second tooth height is about 1:70 to about 3:16.

2. The comb of claim 1, wherein the first ratio between the first tooth height and the second tooth height is approximately 3:46.

3. The comb of claim 1, wherein the first intermediate tooth is directly adjacent the first outer tooth, and wherein the second intermediate tooth is directly adjacent the second outer tooth.

4. The comb of claim 3, wherein the intermediate teeth including a third intermediate tooth, the third intermediate tooth defining a third tooth height, wherein a second ratio between the second tooth height and the third tooth height approximately equal to the first ratio.

5. The comb of claim 1, wherein the tooth height of at least one intermediate tooth is adjustable.

6. The comb of claim 1 further comprising an overhang region defining a slot sized to receive a blade when the comb is attached to the electric clipper.

7. The comb of claim 1, wherein:
a first distance is defined between the first outer tooth and the first intermediate tooth, the first intermediate tooth directly adjacent the first outer tooth;
a second distance is defined between the second outer tooth and the second intermediate tooth, the second intermediate tooth directly adjacent the second outer tooth; and
a first intermediate tooth distance is defined between a first pair of adjacent teeth of the intermediate teeth,
wherein both the first distance and the second distance are greater than the first intermediate tooth distance.

8. The comb of claim 1 in combination with an electric trimmer, the electric trimmer comprising a blade assembly having at least one blade, the at least one blade having a blade edge and defining a cutting line.

9. The comb of claim 8, wherein:
each intermediate tooth defines a cutting height, the cutting height for each of the intermediate teeth representing the shortest distance between the cutting line and the outer-most point on the skin-contacting edge of each of the intermediate teeth, and
wherein a first cutting height defined by the first intermediate tooth is greater than a second cutting height defined by the second intermediate tooth, and wherein a cutting ratio between the first cutting height and the second cutting height is about 1:70 to about 3:16.

10. A comb for an electric trimmer, the comb comprising:
a back;
a front, at least one of the front and the back including a blade engagement section for removeably coupling the comb to a blade assembly;
a first side edge extending from the back to the front;
a second side edge extending from the back to the front and opposite the first side edge;
teeth extending to the front, each of the teeth having a tip, the teeth further comprising:
a first outer tooth located at or adjacent the first side edge;
a second outer tooth located at or adjacent the second side edge; and
intermediate teeth spaced apart from each other and positioned between the first outer tooth and the second outer tooth, the intermediate teeth are spaced apart from each other and positioned between the first outer tooth and the second outer tooth, the intermediate teeth including a first intermediate tooth and a second intermediate tooth,
wherein each intermediate tooth defines a tooth height, wherein a first tooth height defined by the first intermediate tooth is greater than a second tooth height defined by the second intermediate tooth, and wherein a first ratio between the first tooth height and the second tooth height is about 1:70 to about 3:16.

11. The comb of claim 10, wherein the first ratio is approximately 3:46.

12. The comb of claim 10, wherein the first outer tooth has a first front side guard, and wherein the second outer tooth has a second front side guard.

13. The comb of claim 10, wherein:
a first distance is defined between the first outer tooth and the first intermediate tooth, the first intermediate tooth directly adjacent the first outer tooth,
a second distance is defined between the second outer tooth and the second intermediate tooth, the second intermediate tooth directly adjacent the second outer tooth,
a first intermediate tooth distance is defined between a first pair of adjacent teeth of the intermediate teeth, and
both the first distance and the second distance are greater than the first intermediate tooth distance.

14. The comb of claim 13, wherein the first distance and the second distance are approximately equal.

15. The comb of claim 13, wherein a second intermediate tooth distance is defined between a second pair of adjacent teeth of the intermediate teeth, the second intermediate tooth distance approximately equal to the first intermediate tooth distance.

16. A comb for an electric trimmer, the comb comprising:
a back;
a front, at least one of the front and the back including a blade engagement section for removeably coupling the comb to a blade assembly;
a first side edge extending from the back to the front;
a second side edge extending from the back to the front and opposite the first side edge;
teeth extending to the front, each of the teeth having a tip, the teeth comprising:
a first outer tooth located at or adjacent the first side edge;
a second outer tooth located at or adjacent the second side edge; and
intermediate teeth spaced apart from each other and positioned between the first outer tooth and the second outer tooth, the intermediate teeth including a first intermediate tooth directly adjacent the first outer tooth, a second intermediate tooth directly adjacent the second outer tooth, and a pair of adjacent intermediate teeth,
wherein a first distance is defined between the first outer tooth and the first intermediate tooth, a second distance is defined between the second outer tooth and the second intermediate tooth, wherein an intermediate tooth distance is defined between the pair of adjacent intermediate teeth, and wherein both the first distance and the second distance are greater than the intermediate tooth distance.

17. The comb of claim 16, wherein the first distance and the second distance are approximately equal.

18. The comb of claim 16, wherein each of the teeth comprises:
an overhang region,
a base region, and
a slot formed between the overhang region and the base region, the slot configured to receive a plurality of blades of the blade assembly.

19. The comb of claim 18 further comprising:
a skin-facing side and an opposing blade-facing side, each of the teeth having a skin-contacting edge on the skin-facing side, the blade-facing side having a planar blade-abutting surface rearward from the teeth and defined between the first side edge and the second side edge; and
a cutting plane bisecting the teeth perpendicular to the planar blade-abutting surface,
wherein a blade edge of the plurality of blades intersects the cutting plane if the plurality of blades are inserted into the slot, wherein the base region is located on the blade-facing side, and wherein the each of the intermediate teeth has a tooth height representing the shortest distance between the base region of each of the intermediate teeth and an outer-most point on the skin-contacting edge of each of the intermediate teeth.

20. The comb of claim 19 wherein the intermediate teeth further comprise a third intermediate tooth located between the first intermediate tooth and the second intermediate tooth, wherein the first intermediate tooth has a first tooth height, the second intermediate tooth has a second tooth height, and the third intermediate tooth has a third tooth height, and wherein the first tooth height is greater than the third tooth height, and wherein the third tooth height is greater than the second tooth height.
